(19) United States
(12) Patent Application Publication
(10) Pub. No.: US 2025/0346475 A1
(43) Pub. Date: Nov. 13, 2025

(54) CONTAINER OPENER

(71) Applicant: Draft Top, Inc., Ewing, NJ (US)

(72) Inventors: Armand J. Ferranti, Long Branch, NJ (US); Alexander A. Caracappa, Medford, MA (US); Lyra Wanzer Turner, E. Montpelier, VT (US); Paul Tuhy, Moultonborough, NH (US); Shawn Harlan, Rhoadesville, VA (US); Sean Kelly, Kennebunk, ME (US)

(21) Appl. No.: 18/867,576

(22) PCT Filed: Jun. 22, 2023
(86) PCT No.: PCT/US2023/025981

§ 371 Date: Nov. 20, 2024

Related U.S. Application Data
(60) Provisional application No. 63/366,941, filed on Jun. 24, 2022.

(51) Int. Cl. B67B 7/46; B67B 7/40

(52) U.S. Cl. CPC B67B 7/30; B67B 7/403; B67B 2007/303

(57) ABSTRACT

A container opener includes a base including a first semicircular portion: an arm including a second semicircular portion and in slidable communication with the base: a blade attached to the arm: wherein when the base and the arm are brought together the first and the second semicircular portions are configured to capture a container and the blade is pushed to contact an inner rim of the container.

### CROSS REFERENCE TO RELATED APPLICATIONS

This application claims the benefit of U.S. Provisional Patent Application No. 63/366,941, filed Jun. 24, 2022, which is hereby incorporated by reference for all purposes as if fully set forth herein.

### FIELD

The present disclosure generally relates to the technical field of cutlery and bar utensils, and in particular, an apparatus and method for opening a planar portion of a sealed container.

### BACKGROUND

Traditional opening devices remove a planar upper surface of a sealed container. However, these devices are limited in the types of containers they can open and are constrained in the method of accessing the container contents.

A recent trend among soda or beverage cans, e.g., beer cans, is to engage the installed tab located at the planar top surface of the can while including a perforated indentation opposite the tab to improve flow of the soda or beverage from the can once opened. However, this conventional technique requires a separate tool, such as a key or other instrument, to puncture the perforated indentation. In addition, for applications in a bar, restaurant, or concession environment, the two-step process of this conventional technique is cumbersome or impractical and inhibits a bartender or concession worker from quickly opening and delivering the container. Moreover, engaging the installed tab and puncturing the perforated indentation may only increase flow of the liquid from the can based on the limited dimensions of the tabbed mouth opening. For example, the perforated indentation constrains the flow of denser liquids. Concurrently, the developmental costs for changing and implementing a perforated indentation design are impractical for the limited amount of target consumers. Moreover, the conventional installed tab, the conventional installed tab and perforated indentation, or traditional opening devices create only a small opening in the container, which hinders the user from smelling the full aroma of the container contents, e.g., beer, thereby effecting the user's sense of taste.

Additionally, traditional opening devices, either manually operated or machine operated, present various access challenges for planar top containers without an engagement tab or mouth. For example, manually operated opening devices use a single blade to remove the entire planar upper surface. These conventional devices require many rotations of a handle or crank to utilize the single blade to cut around the entire circumferential edge of the container. In another example, machine operated opening devices are limited by the speed of the motor during the opening process. Furthermore, both the manually operated and machine operated devices require a user to align and engage the single blade along the circumferential edge before commencing the opening process, which is both time consuming and cumbersome. Moreover, the distance that the shoulder or lip of various containers protrudes outward from the engagement point of the blade can make the opening device ineffective by not allowing the blade to puncture and engage the container surface at an appropriate angle. The shoulder or lip also prevents certain manual devices from fitting on the can and engaging with the rim, while other machine operated devices cause the can to tip at an angle to engage the rim which would cause the contents to spill out during the top removal process.

Additionally, although traditional manually operated and machine operated devices remove the planar upper surface of a container, these devices leave sharp edges on the container upon removal that are harmful to the user. The contents of such containers subsequently need to be removed to an intermediate container for user safety following the opening process.

### SUMMARY

To overcome the problems described above, embodiments of the present disclosure include a container opener that includes features that move relative to each other and a blade to cut a container once engaged in the container opener and the container and the container opener are rotated relative to each other.

In an embodiment of the present disclosure, a container includes a base including a first semicircular portion; an arm including a second semicircular portion and in slidable communication with the base; and a blade attached to the arm; wherein when the base and the arm are brought together the first and the second semicircular portions are configured to capture a container and the blade is pushed to contact an inner rim of the container.

The container opener can further include a tab grabber attached to the arm and configured to slide under a tab on a top of the container when the container opener and the container are rotated relative to each other after the base and the arm are brought together.

In an aspect, the tab grabber is configured to retain the top of the container when the top is cut off of the container and the container is separated from the container opener.

In an aspect, tab grabber is semicircular.

In an aspect, the blade is configured to puncture the container when the base and the arm are brought together.

In an aspect, the blade is configured to cut off a top of the container when the container and the container opener are rotated relative to each other after the base and the arm are brought together.

In an aspect, the first and the second semicircular portions are configured such that a rim of the container can rest on the first and the second semicircular portions when the base and the arm are brought together.

In an aspect, one of the base and the arm include a clip to lock the base and the arm together.

In another embodiment of the present disclosure, a container opener includes a base including a first semicircular portion; an arm including a second semicircular portion and hinged to the base; and a blade attached to the arm; wherein when the base and the arm are brought together the first and the second semicircular portions are configured to capture a container and the blade is pushed to contact an inner rim of the container. The container opener can further include a tab grabber attached to the arm and configured to slide under a tab on a top of the container when the container opener and the container are rotated relative to each other after the base and the arm are brought together.

In an aspect, the tab grabber is configured to retain the top of the container when the top is cut off of the container and the container is separated from the container opener.

In an aspect, the tab grabber includes a semicircular portion.

In an aspect, the blade is configured to puncture the container when the base and the arm are brought together.

In an aspect, the blade is configured to cut off a top of the container when the container and the container opener are rotated relative to each other after the base and the arm are brought together.

In an aspect, the first and the second semicircular portions are configured such that a rim of the container can rest on the first and the second semicircular portions when the base and the arm are brought together.

In another embodiment of the present disclosure, a container opener includes a top liner attached to the top cover; a clamp attached to the top liner; a bottom liner attached to the clamp; and a blade attached to the clamp, wherein when the clamp is configured to capture a container and the blade is pushed to an inner rim of the container when the blade arm is activated.

In an aspect, the clamp includes a blade arm that is spring loaded to a clamp arm.

In an aspect, the blade arm and the clamp arm are configured to close around the container when the clamp is activated, the blade is attached to the blade arm, and the blade closes in on the container when the blade arm is activated.

In an aspect, the blade arm and the clamp arm are brought together to activate the clamp.

In an aspect, the top liner includes a tab grabber attached that is configured to slide under a tab on a top of the container when the container opener and the container are rotated relative to each other after the base and the arm are brought together.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 to FIG. 15 are used to describe a container opener device of an embodiment of the present disclosure.

FIG. 16 to FIG. 28 are used to describe a container opener device of another embodiment of the present disclosure.

FIG. 29 and FIG. 30 are used to describe an aspect of the disclosure including a tab grabber.

FIG. 31A to FIG. 33B are used to describe an aspect of the disclosure including a locking mechanism.

FIG. 34 to FIG. 42 are used to describe a container opener device of another embodiment of the present disclosure.

### DETAILED DESCRIPTION

The embodiments described herein are directed to opening sealed containers, such as sealed cans, which permit the user to separate a portion or an entire upper planar surface of the container from a pressed outer edge or rim of the container.

Additionally, by way of example, the embodiments described herein permit the user to safely open and/or remove the upper planar surface of a sealed container with both ease and efficiency. Further, by way of example, the embodiments described herein permit the user to open and/or remove the entire upper planar surface of such container with minimal resulting sharp edges. Moreover, the embodiments described herein permit the user to smell the full aroma of the container contents, e.g., beer, thereby allowing the user to fully enjoy the taste of the container contents.

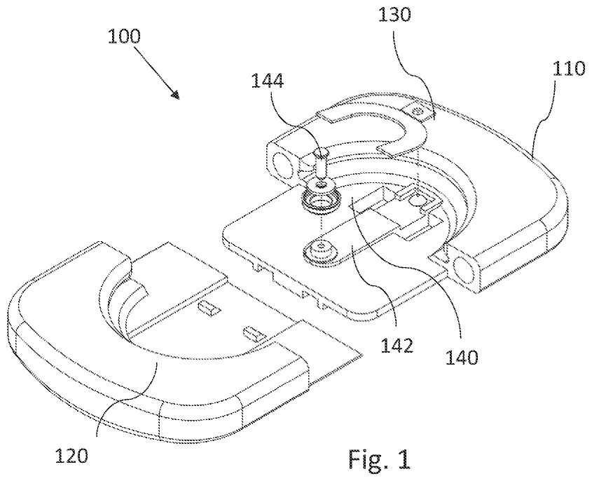

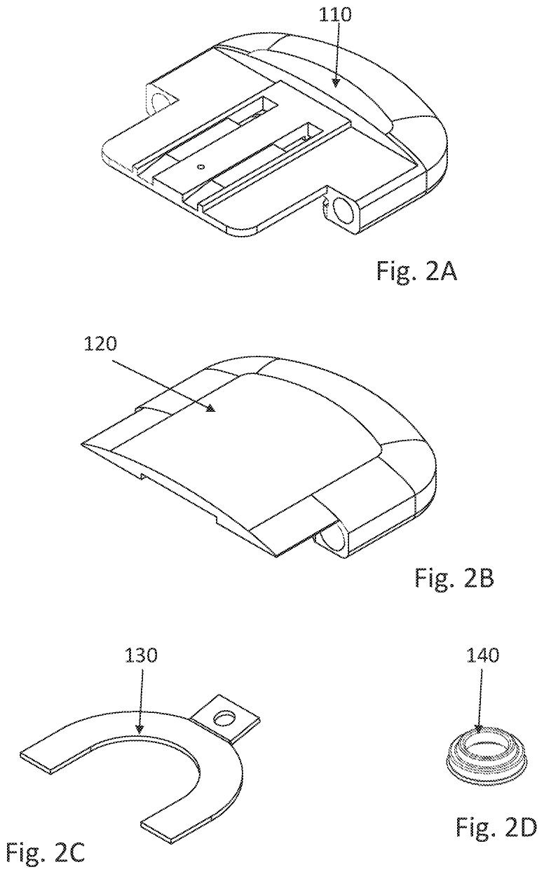

FIGS. 1-15 are views of a container opener 100 according to an embodiment of the disclosure. FIG. 1 is an exploded view of the container opener 100 and FIGS. 2A-2D show components of the container opener including an arm 110, a base 120, a tab grabber 130, and a blade 140. FIG. 1 shows that the blade 140 can be round and attached to a blade holder 142 via a fastener 144 through the blade 140. The fastener 144 can be a rivet, pin, screw, bolt, on any suitable device to secure the blade 140 to the blade holder 142.

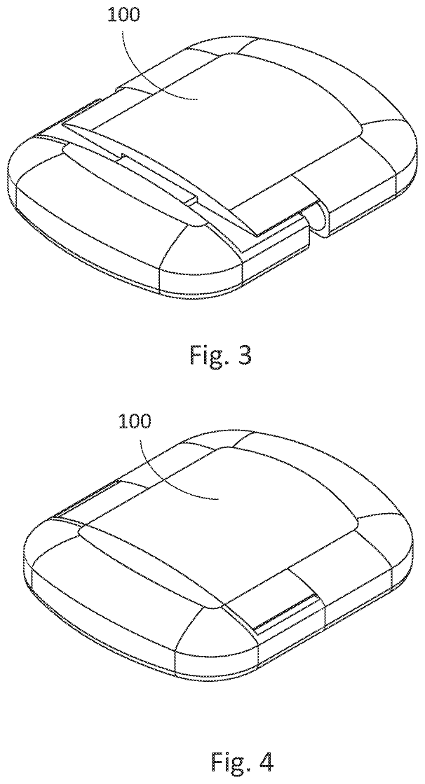

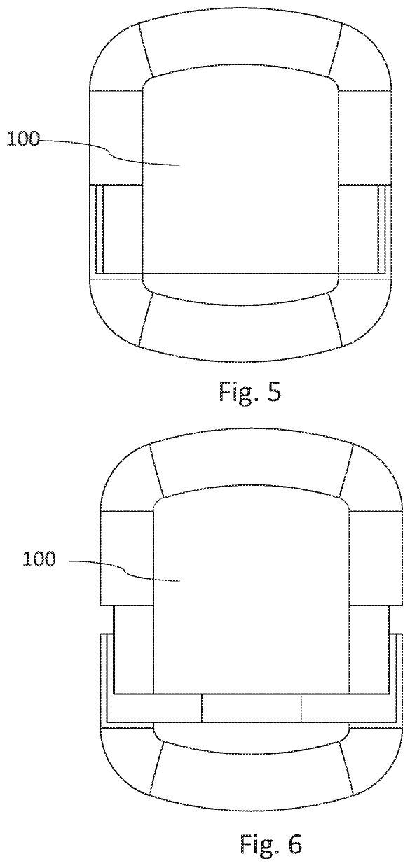

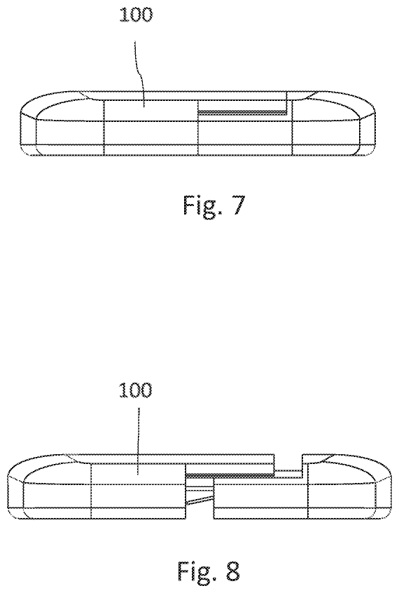

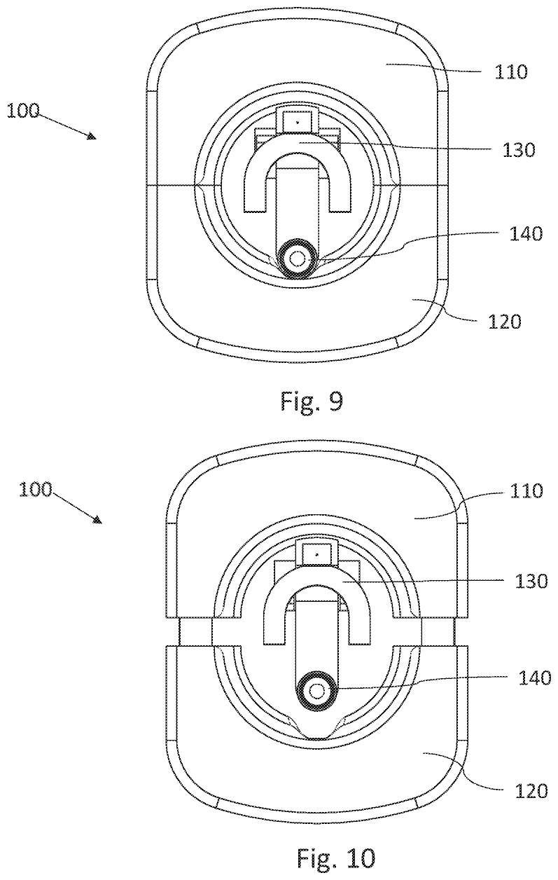

FIG. 3 is a top perspective view of the container opener 100 in an open state. FIG. 4 is a top perspective view of the container opener 100 in a closed state. FIG. 5 is a top view of the container opener 100 in the closed state. FIG. 6 is a top view of the container opener 100 in the open state. FIG. 7 is a side view of the container opener 100 in the closed state. FIG. 8 is a side view of the container opener 100 in the open state. FIG. 9 is a bottom view of the container opener 100 in the closed state. FIG. 10 is a bottom view of the container opener 100 in the open state. As shown, the arm 110 and the base 120 can be arranged such that they are interconnected and can slide apart to define an opening in which a container (i.e., a can) can be placed for opening. Once the can is in place the arm 110 and the base 120 can be compressed together to clamp around the can, as further described below.

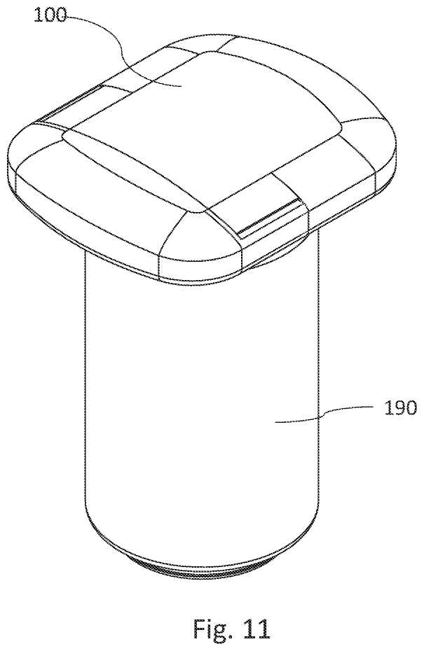

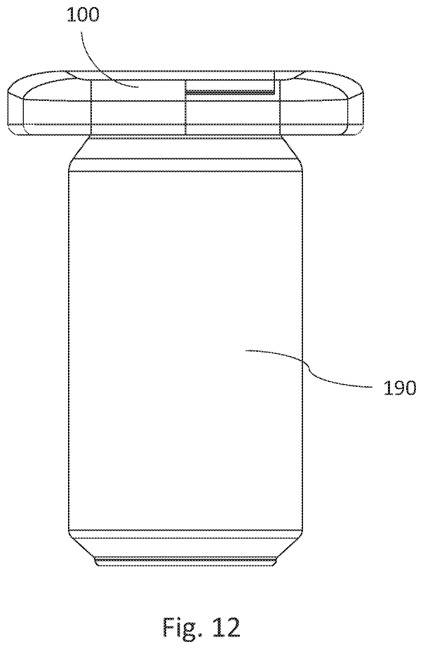

FIG. 11 is a top perspective view of the container opener 100 closed around the top of a can 190. FIG. 12 is a side view of the container opener 100 closed around the top of the can 190.

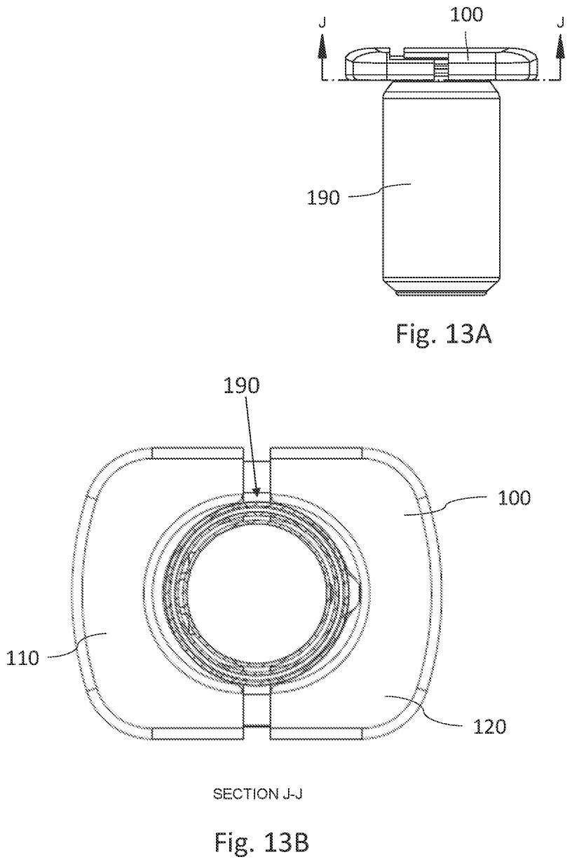

FIG. 13A is a side sectional view of the container opener 100 in the open state at a plane just below the rim of the can 190. FIG. 13B is a view of section J-J of FIG. 13A. These views show how when the arm 110 and base 120 are open, they allow the larger diameter of the can 190 to fit into the container opener 100 and rest against the bottom surface of the arm 110.

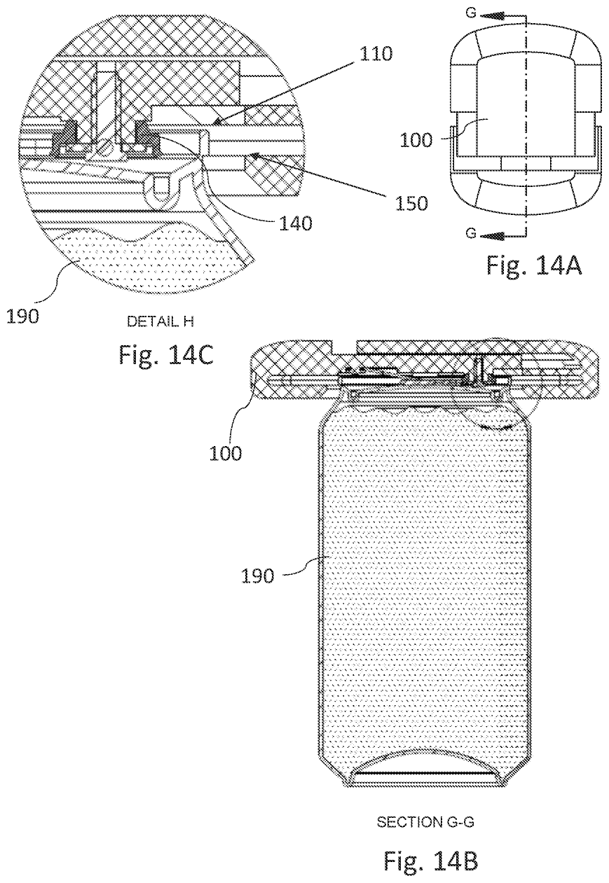

FIG. 14A is a top view of the container opener 100 in the open state around a can 190. FIG. 14B is a view of section G-G of FIG. 14A. This is a side section view of the open container opener 100 with the can 190. In FIG. 14C, Detail H of FIG. 14B, the blade 140 is retracted, which is connected to the arm 110, to leave space for the inner rim of the can 190 to enter the container opener 100 without hitting the blade 140. There is also a gap between the outer rim of the can 191 and a clamp 150 on the arm 110 used to secure the can 190 with the container opener 100.

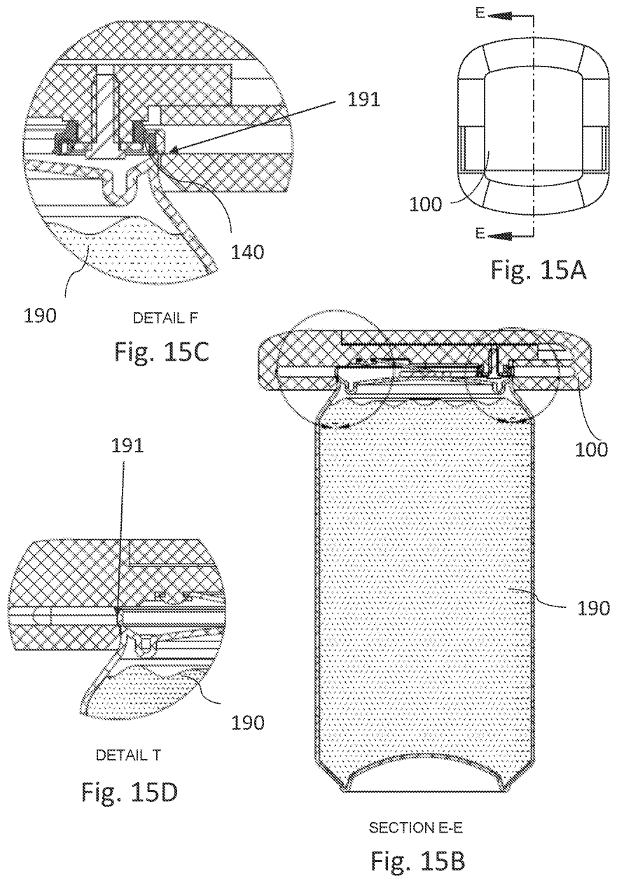

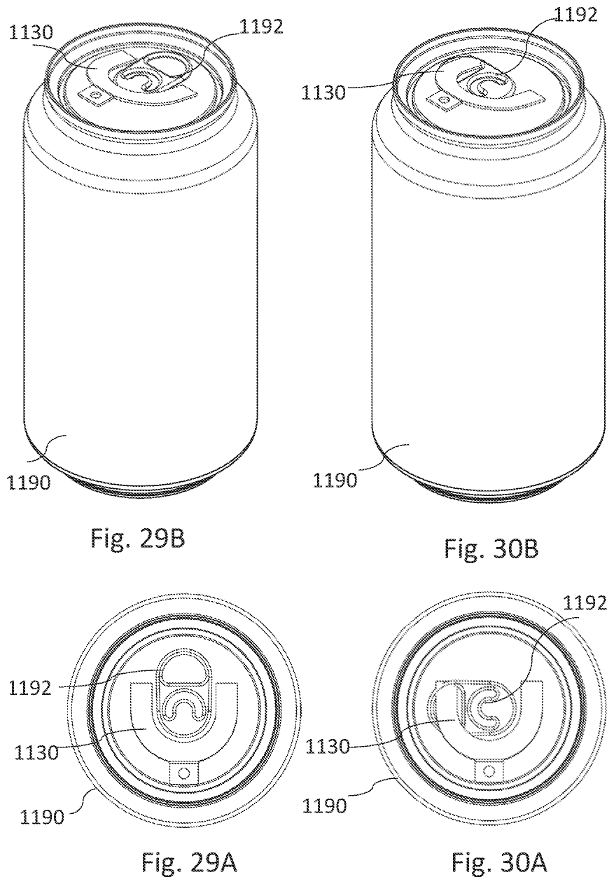

FIG. 15A is a top view of the container opener 100 in the closed state around the can 190. FIG. 15B is a view of section E-E of FIG. 15A. FIGS. 15C and 15D are Detail F and Detail T, respectively, of FIG. 15B. When the arm 110 and body 120 are squeezed together, the clamp 150 on the arm 110 pushes the outer diameter of the can 190 (below the rim) against an identical clamp on the base 120. This causes the can 190 to be secured by the two opposing clamp features and encircles the can 190. It also makes the rim of the can 191 rest on top of the clamp features. FIG. 15B shows how the blade 140 is engaged to puncture the inner rim of the can 191. Once the arm 110 and base 120 are squeezed together the user holds the two components together and rotates the container opener 110 with respect to the can 190 to cut off the top of the can 192. Operation of a tab grabber is described below with respect to FIG. 29A to FIG. 30B.

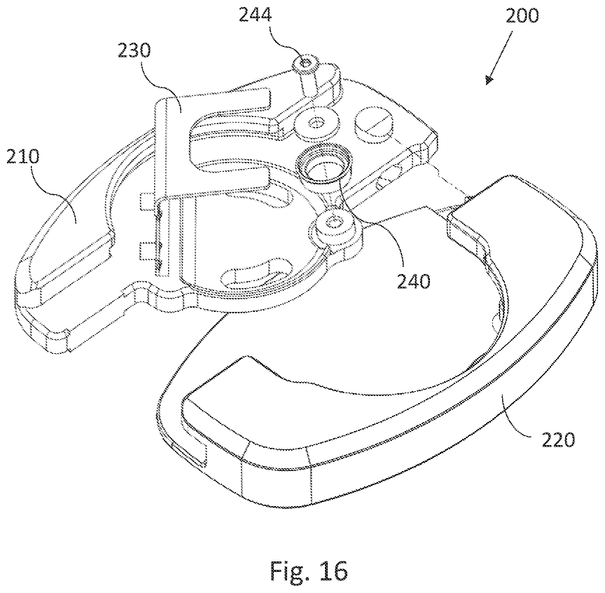

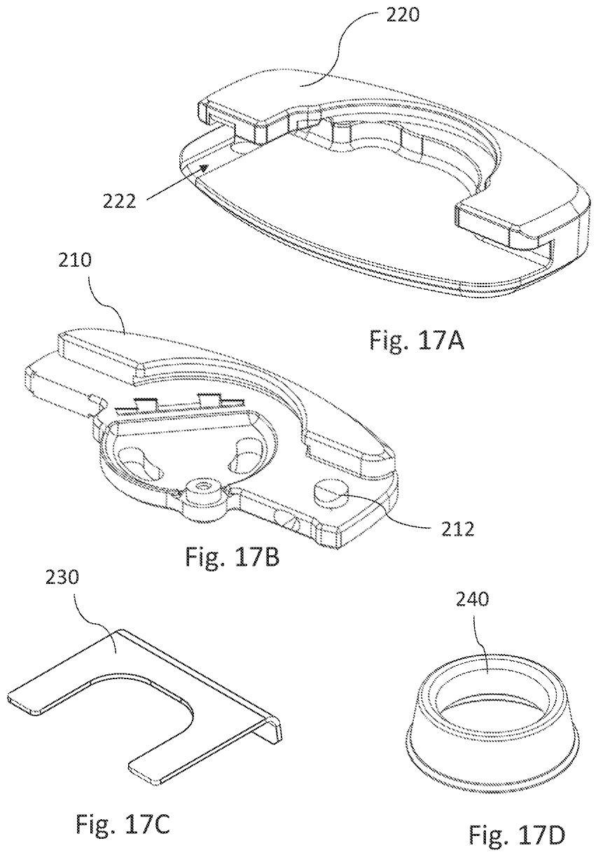

FIGS. 16-28 are views of a container opener 200 according to another embodiment of the disclosure that hinges closed rather than slides closed. FIG. 16 is an exploded view of the container opener 200. FIGS. 17A-17D show components of the container opener 200 including an arm 210, a base 220, a tab grabber 230, and a blade 240. FIG. 16 shows that the blade 240 can be round and attached to arm 210 via a fastener 244 through the blade 240. The fastener 244 can be a rivet, pin, screw, bolt, on any suitable device to secure the blade 240 to the arm 210.

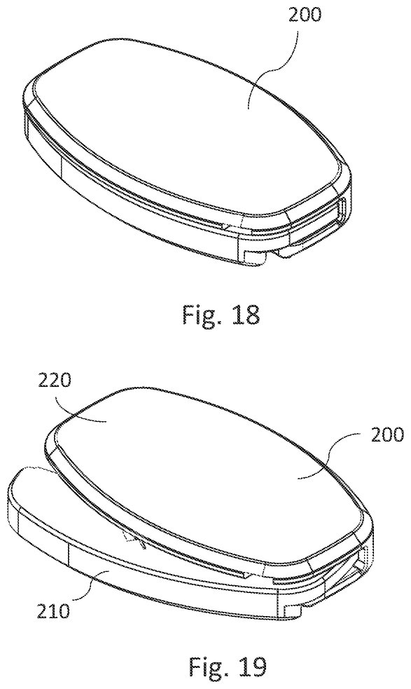

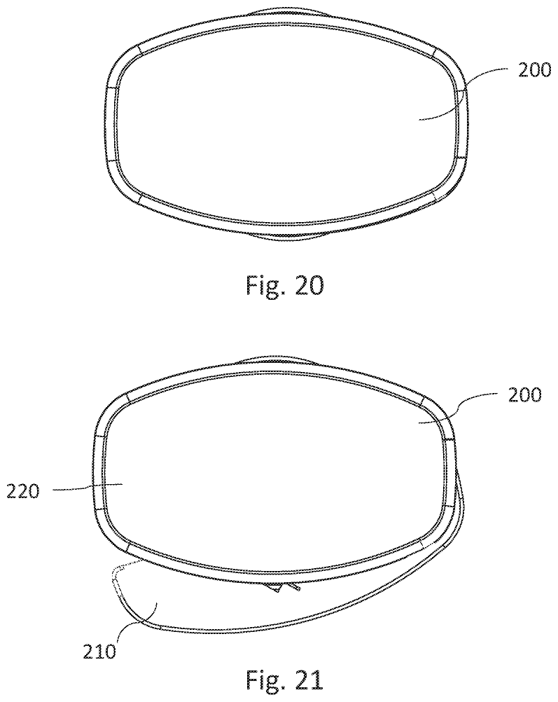

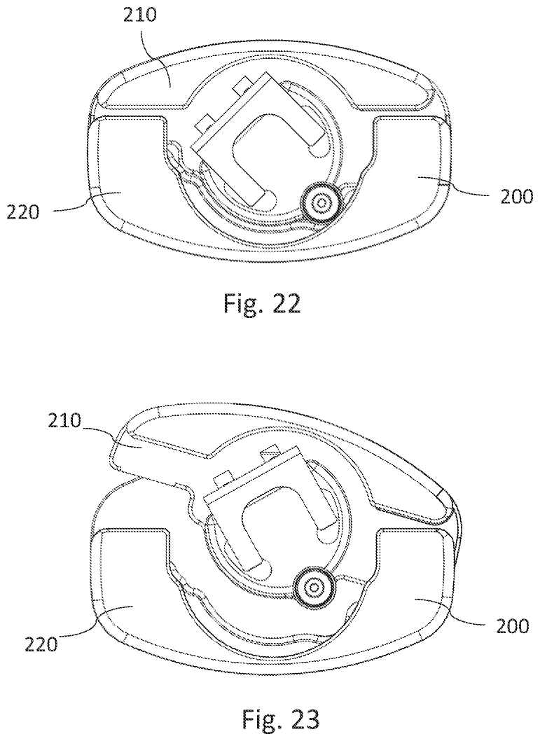

FIG. 18 is a top perspective view of the container opener 200 in a closed state. FIG. 19 is a top perspective view of the container opener 200 in an open state with the arm 210 rotated outside of the profile of the base 220. FIG. 20 is a top view of the container opener 200 in the closed state. FIG. 21 is a top view of the container opener 200 in the open state. FIG. 22 is a bottom view of the container opener 200 in the closed state. FIG. 23 is a bottom view of the container opener 200 in the open state. As shown, the arm 210 and the base 220 can be arranged such that they are interconnected and hinged such that they can rotate apart to define an opening in which a container (i.e., a can) can be placed for opening. FIG. 17 shows that the hinge can be created via a tab 212 protruding from arm 210 that is press fit into a slot 222 defined in the base 220. Once the can is in place the arm 210 and the base 220 can be rotated together to clamp around the can, as further described below.

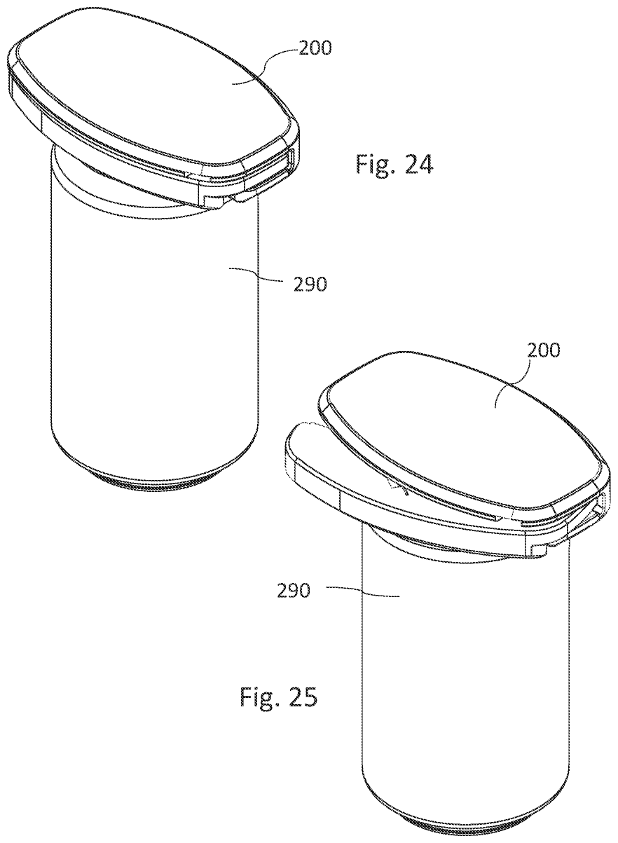

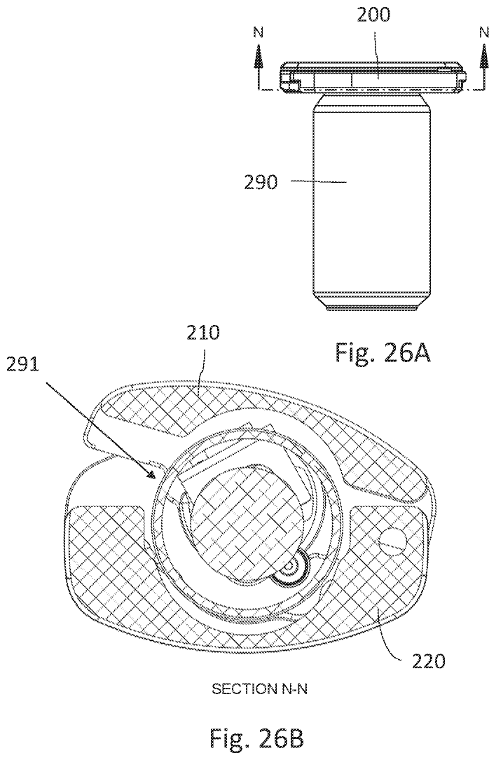

FIG. 24 is a top perspective view of the container opener 200 in a closed state with a can 290. FIG. 25 is a top perspective view of the container opener 200 in the open state with a can 290. FIG. 26A is a side view of the container opener 200 in the open state with a can 290. FIG. 26B is a view of the container opener along section N-N of FIG. 26A. This view is showing a section view of the container opener 200 when the container opener 200 is open at a plane just below a rim of the can 291. This is showing how when the arm 210 and base 220 are hinged open, they allow the larger diameter of the can 290 to fit into the container opener 200 and rest against a bottom surface of the arm 210.

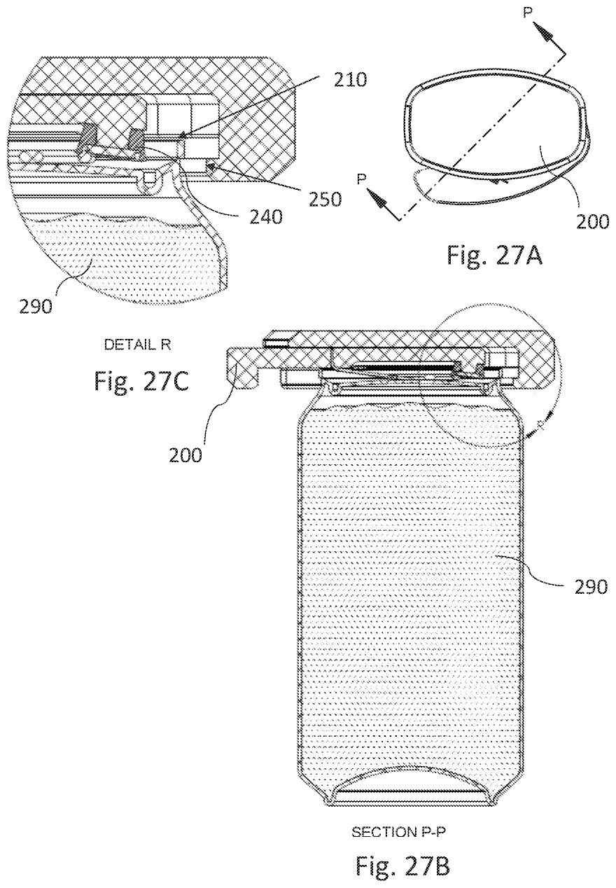

FIG. 27A is a top view of the container opener 200 in the open state with a can 290. FIG. 27B is a view of the container opener 200 and the can 290 along section P-P of FIG. 27A. In FIG. 27C, Detail R, it can be seen how the blade 240 is retracted, which is connected to the arm 210, to leave space for the inner rim of the can 291 to enter the container opener 200 without hitting the blade 240. There is also a gap between the outer rim of the can 291 and a can clamp 250.

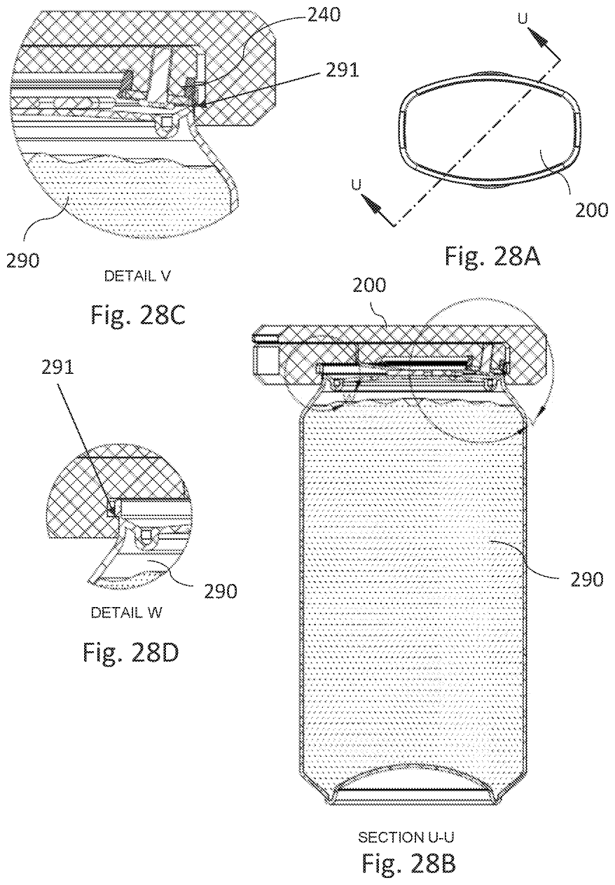

FIG. 28A is a top view of the container opener 200 in the closed state with a can 290. FIG. 28B is a view of the container opener 200 and the can along section U-U of FIG. 28A. FIGS. 28C and 28D are of Detail V and Detail W, respectively, of FIG. 28B. When the arm 210 and base 220 are squeezed together, the clamp 250 on the arm 210 pushes the outer diameter of the can (below the rim) against the identical clamp feature on the base 220. This causes the can 290 to be secured by the two clamp features that encircles the can 290. It also makes the rim of the can 291 rest on top of the clamp features. This view is also showing how the blade 240 is engaged to puncture the inner rim of the can 291. Once the arm 210 and base 220 are squeezed together the user holds the two together and rotates the container opener 200 with respect to the can 290 to cut off the top of the can.

FIGS. 29A-30B show an aspect of the disclosure including a tab grabber 1130 that grabs a tab opener 1192 (i.e., tab) on the top of a can 1190. Other portions of the various container opener embodiments are omitted so that only the tab grabber 1130 is visible. FIGS. 29A and 30A are top views of the can 1190 and show the tab grabber 1130 and the tab 1192 on the top of the can 1190. FIGS. 29B and 30B are respective perspective views corresponding to FIGS. 29A and 30A.

These figures show the can 1190 positioned such that the arms of the tab grabber 1130 are pushed against the top surface of the can 1130 during operation of a container opener. When the can 1190 and a container opener are being rotated with respect to each other to cut the top off the can 1190, the tab 1130 also rotates with the can 1190 and gets forced on top of the arms of the tab grabber 1130. When a container opener is opened to remove the can 1190 after cutting the top from the can 1190, the top of the can 1190 is clipped onto either arm of the tab grabber 1130 via the tab 1192 and held by the tab grabber 1130 as the container opener is separated from the opened can 1190.

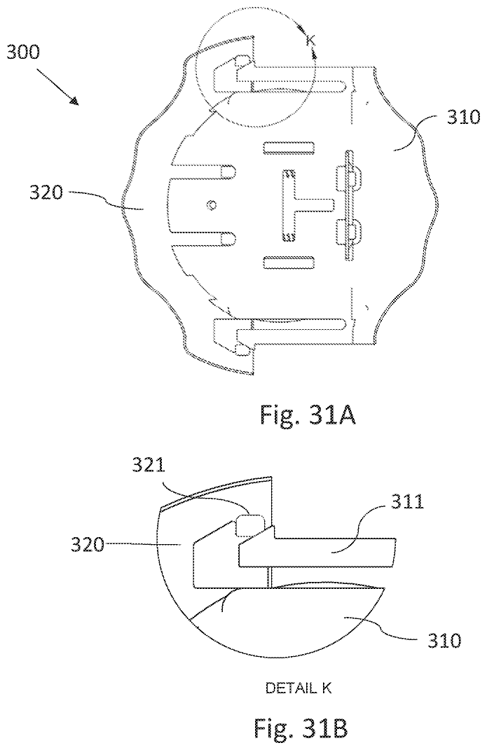

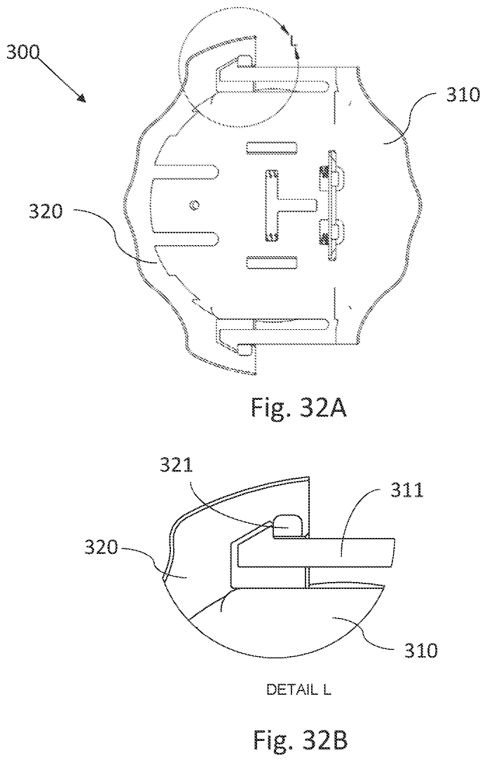

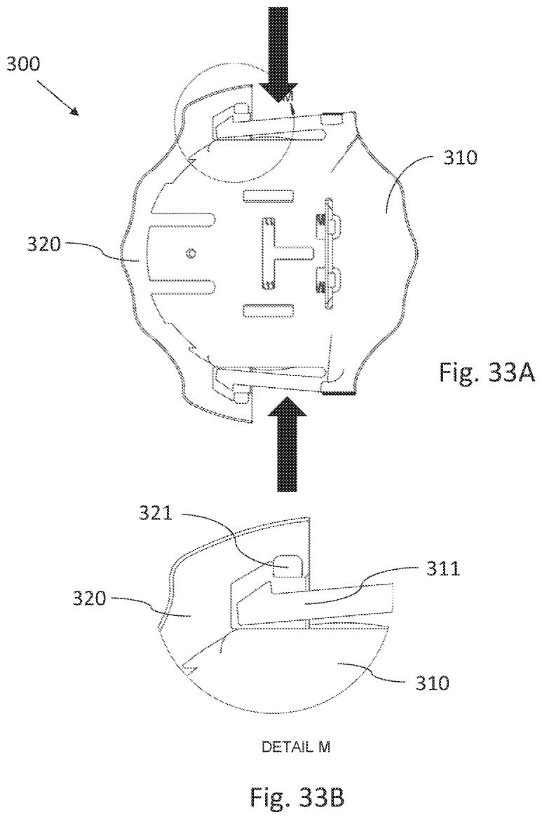

FIGS. 31A-33B show an aspect of the disclosure where a container opener 300 includes at least one clip 311 that holds an arm 310 and a base 320 closed for storage when the two are squeezed together. FIG. 31A is a top view of the container opener 300 in the open state with FIG. 31B, Detail K, showing one clip 311 on one side that is not engaged to lock the arm 310 and the base 320 together. FIG. 32A is a top view of the container opener 300 in the closed state with FIG. 32B, Detail L, showing the clip 311 on one the side that is engaged on a tab 321 to lock the arm 310 and the base 320 together when the two are pushed together. After the base 320 and the arm 310 are locked together, FIGS. 33A and 33B, Detail M, show that when the user pushes the clips 311 in towards the center of the container opener 300 (in the directions of the arrows) this force releases the clips 311 from the tabs 321 and allows the arm 310 and base 320 to separate for use.

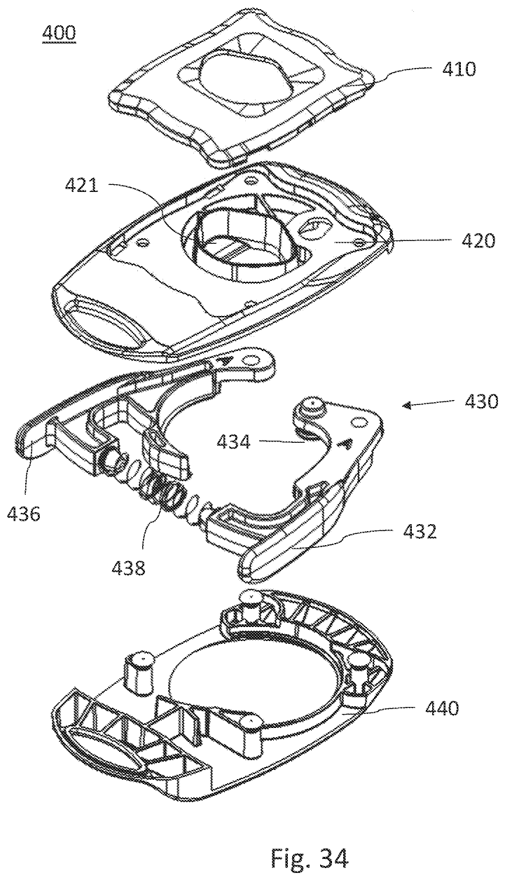

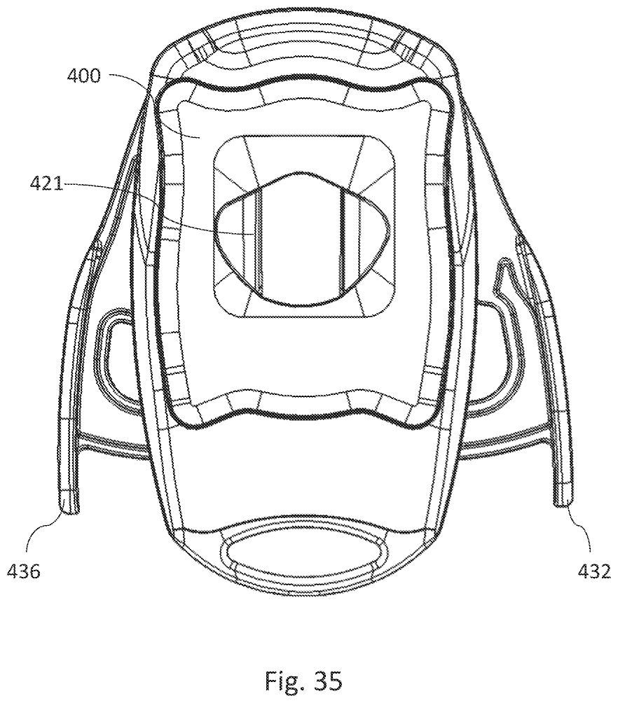

FIGS. 34-42 are views of a container opener 400 according to another embodiment of the disclosure. The container opener 400 includes a lid grabbing feature that is built into a molded top liner of the container opener 400 rather than being a separate component.

FIG. 34 is an exploded view of the container opener 400. As shown, the container opener 400 can include a top cover 410, a top liner 420, a clamp 430, and a bottom liner 440. The top liner 420 can include a tab grabber 421 to grab the tab on the top of a can. The clamp 430 can include a blade arm 432, a blade 434 on the blade arm 432 to cut the can, a clamp arm 436, and a spring 438 to spring load the blade arm 432 and the clamp arm 436.

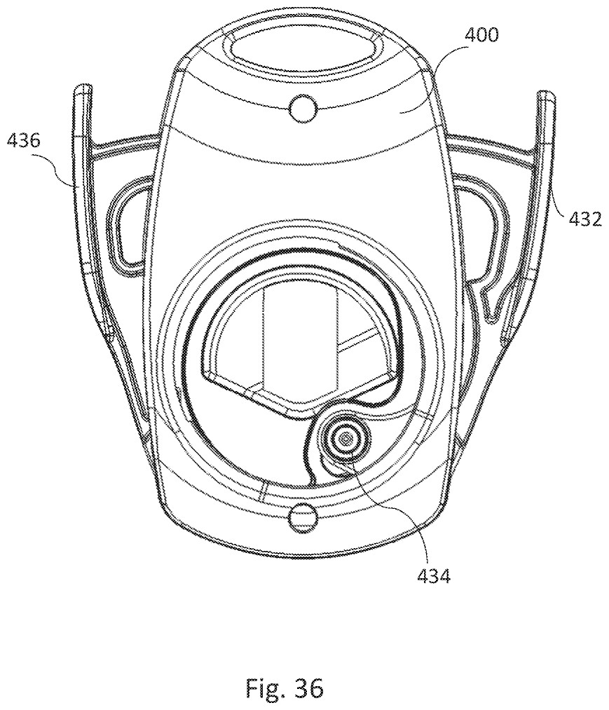

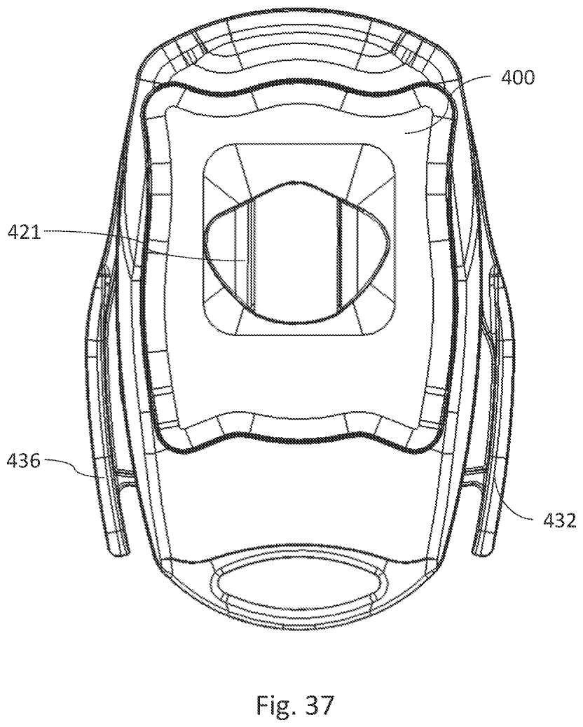

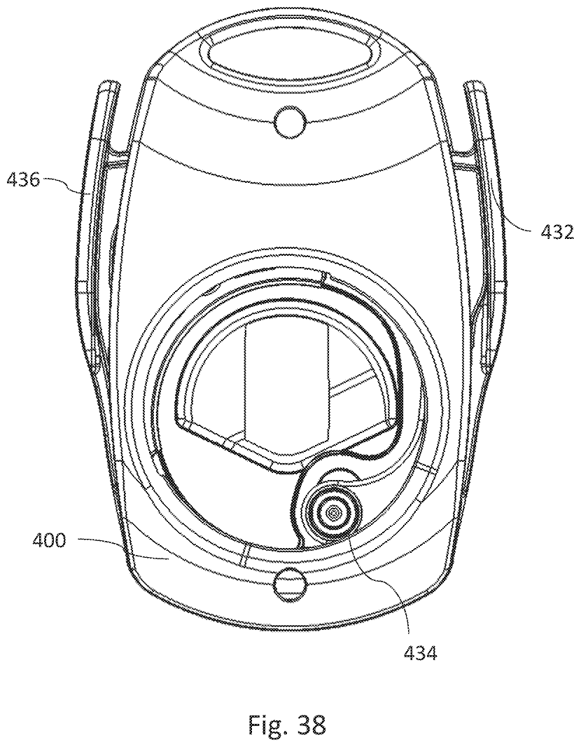

FIG. 35 is a top view of the container opener 400 with the clamp arm 436 and the blade arm 432 in an open position. FIG. 36 is a bottom view of the container opener 400 showing that the container opener 400 can use a single blade 434 to cut a can.

FIG. 37 is a top view of the container opener 400 with the clamp arm 436 and the blade arm 432 in a closed position. FIG. 38 is a bottom view of the container opener 400 with the clamp arm 436 and the blade arm 432 in a closed position. The clamp and blade arms 436, 432 are compressed inwards after the can is inserted, and the blade 434 closes in on the can (not shown). The can and the container opener 400 then rotated with respect to each other so the blade 434 can cut the entire top off the can. The blade arm 432 actuates the blade 434, and the clamp arm 436 is used to clamp the can once inserted. The clamp 430 allows for the can to still rotate but does not allow for the container opener 400 to accidentally separate from the can during the cutting action.

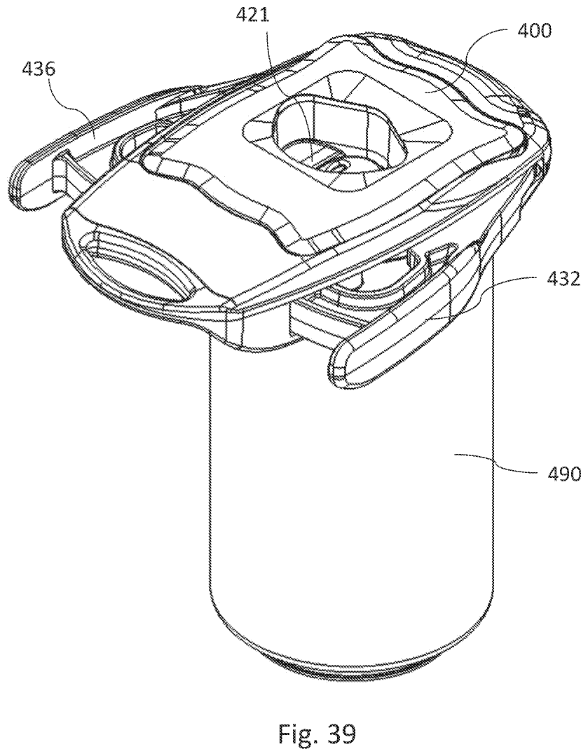

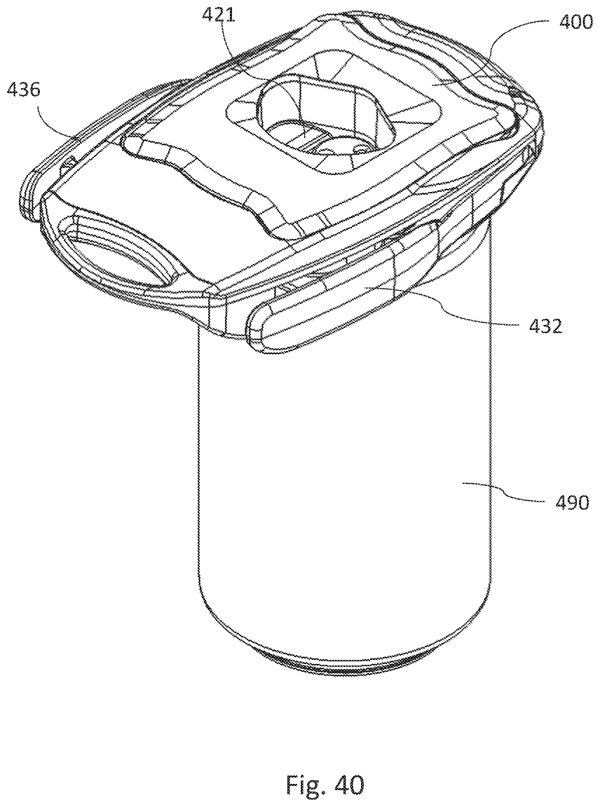

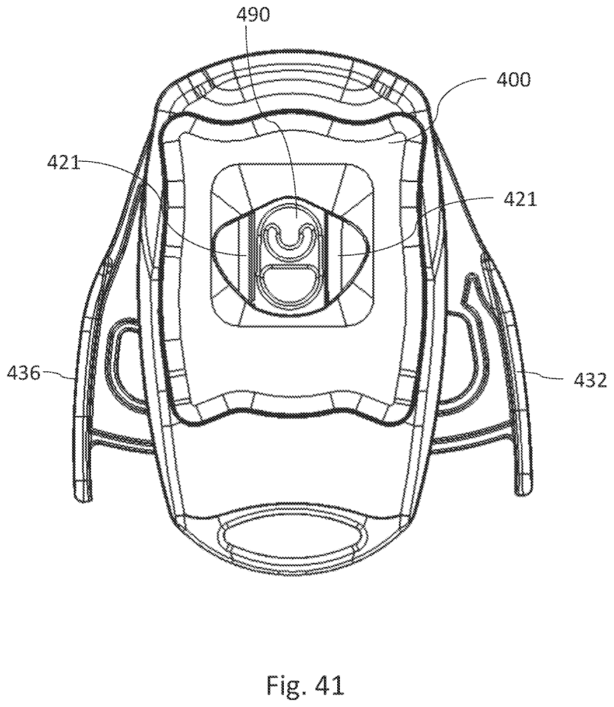

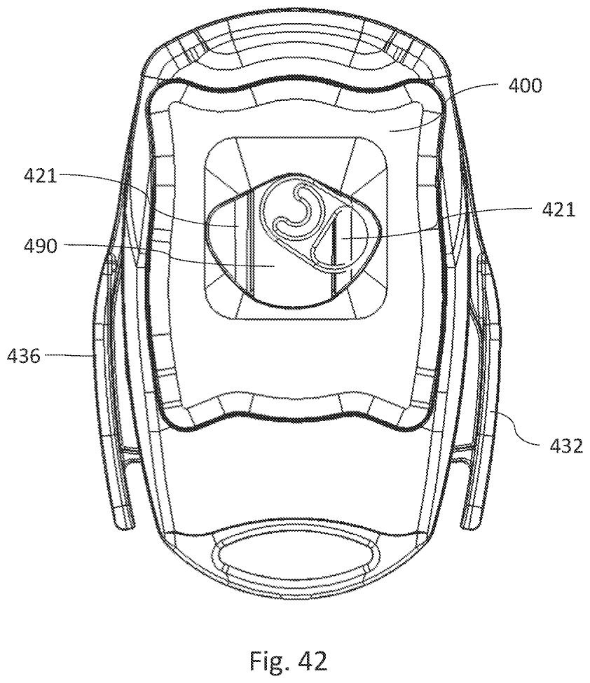

FIGS. 39-42 illustrate operation of the container opener 400. FIG. 39 shows the container opener 400 in position on a can 490 with the clamp and blade arms 436, 432 open. FIG. 40 shows the container opener 400 in position on the can 490 with the clamp and blade arms 436, 432 closed. FIG. 41 is a top view of the container opener 400 in position on the can 490 with the clamp and the blades arms 436, 432 open. The can 490 is inserted into the container opener 400 with the tab oriented between the tab grabber 421 that is included as a portion of the top liner 420. FIG. 42 is a top view of the container opener 400 in position on the can 490 with the clamp and blade arms 436, 432 closed. As the can 490 is rotated with respect to the container opener 400, the tab is wedged on top of the tab grabber 421. After the lid is fully cut, the lid will stay wedged onto the tab grabber 421, so the lid doesn't fall in the drink within the can 490. After the can 490 and the container opener 400 are separated, the lid can be removed from the container opener 400.

In this embodiment described with respect to FIGS. 34-42, the singular blade 434 of the container opener 400 swings in radially versus sliding in. This allows for amplification of force applied to the blade 434 due to leverage at the ends of the clamp arm 436 and the blade arm 432 while making it easier for the user. The opposing clamp arm 436 and blade arm 432 clamp the side of the can 490 to support the can during the cutting operation. If the can is otherwise supported, the clamp arm 436 need not be closed for the blade 434 to cut the lid off the can 490. In an aspect, just the blade arm 432 can be closed after the can 490 is inserted into the container opener 400 and the can 490 can be rotated with respect to the container opener 400 to cut the lid off the can 490. Friction holds the tab onto the tab grabber 421 so that the lid can be removed after the cutting has been completed.

In an aspect of the embodiment not shown, a latch can be included to hold the arms in the closed position for storage.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the disclosure.

What is claimed is:

1. A container opener comprising:
a base including a first semicircular portion;
an arm including a second semicircular portion and in slidable communication with the base; and
a blade attached to the arm; wherein
when the base and the arm are brought together the first and the second semicircular portions are configured to capture a container and the blade is pushed to contact an inner rim of the container.

2. The container opener of claim 1 further comprising a tab grabber attached to the arm and configured to slide under a tab on a top of the container when the container opener and the container are rotated relative to each other after the base and the arm are brought together.

3. The container opener of claim 2, wherein the tab grabber is configured to retain the top of the container when the top is cut off of the container and the container is separated from the container opener.

4. The container opener of claim 3, wherein the tab grabber is semicircular.

5. The container opener of claim 1, wherein the blade is configured to puncture the container when the base and the arm are brought together.

6. The container opener of claim 1, wherein the blade is configured to cut off a top of the container when the container and the container opener are rotated relative to each other after the base and the arm are brought together.

7. The container opener of claim 1, wherein the first and the second semicircular portions are configured such that a rim of the container can rest on the first and the second semicircular portions when the base and the arm are brought together.

8. The container opener of claim 1, wherein one of the base and the arm include a clip to lock the base and the arm together.

9. A container opener comprising:
a base including a first semicircular portion;
an arm including a second semicircular portion and hinged to the base; and
a blade attached to the arm; wherein
when the base and the arm are brought together the first and the second semicircular portions are configured to capture a container and the blade is pushed to contact an inner rim of the container.

10. The container opener of claim 9 further comprising a tab grabber attached to the arm and configured to slide under a tab on a top of the container when the container opener and the container are rotated relative to each other after the base and the arm are brought together.

11. The container opener of claim 10, wherein the tab grabber is configured to retain the top of the container when the top is cut off of the container and the container is separated from the container opener.

12. The container opener of claim 11, wherein the tab grabber includes a semicircular portion.

13. The container opener of claim 9, wherein the blade is configured to puncture the container when the base and the arm are brought together.

14. The container opener of claim 9, wherein the blade is configured to cut off a top of the container when the container and the container opener are rotated relative to each other after the base and the arm are brought together.

15. The container opener of claim 9, wherein the first and the second semicircular portions are configured such that a rim of the container can rest on the first and the second semicircular portions when the base and the arm are brought together.

16. A container opener comprising:
a top liner attached to the top cover;
a clamp attached to the top liner;
a bottom liner attached to the clamp; and
a blade attached to the clamp, wherein
when the clamp is configured to capture a container and the blade is pushed to an inner rim of the container when the blade arm is activated.

17. The container opener of claim 16, wherein the clamp includes a blade arm that is spring loaded to a clamp arm.

18. The container opener of claim 17, wherein:
the blade arm and the clamp arm are configured to close around the container when the clamp is activated,
the blade is attached to the blade arm, and
the blade closes in on the container when the blade arm is activated.

19. The container opener of claim 17, wherein the blade arm and the clamp arm are brought together to activate the clamp.

20. The container opener of claim 16, wherein the top liner includes a tab grabber attached that is configured to slide under a tab on a top of the container when the container opener and the container are rotated relative to each other after the base and the arm are brought together.
